(19) United States
(12) Patent Application Publication
(10) Pub. No.: US 2005/0138435 A1
(43) Pub. Date: Jun. 23, 2005

(54) Method and system for providing a login and arbitrary user verification function to applications

(76) Inventors: Charles W. Kaufman, Sammamish, WA (US); Jane B. Marcus, Westford, MA (US); Murray W. Hurvitz, Needham, MA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/746,221

(22) Filed: Dec. 23, 2003

(51) Int. Cl. H04L 9/00

(52) U.S. Cl. 713/202

(57) ABSTRACT

Disclosed is an independent user verification system and method for providing a user verification service which can be arbitrarily called by one or more applications. A verification command is received from an application. The command contains at least some information for verification by a user. The verification system presents a screen to receive a username and password from the user. The screen contains the information for verification. The verification system verifies the username and password for the application. The verification system is independent from the application, and can service several related or unrelated applications. The information for verification may comprise policy information to be agreed to by a user. The policy information may, for example, relate to information a user must agree to in order to sign-up for a new service offered by the application.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to systems and methods for providing a login and arbitrary verification function to applications. More particularly, the present invention provides a login service including a function that is called to verify a user's identity at some arbitrary time after login.

Corporate web applications often prompt users to approve policies and procedures, such as corporate business ethic guidelines. Users may be asked to review a policy and click a button on the corporate webpage that indicates that the user has read and agreed to the policy. As a security measure, it is preferable for the web application to have a simple way to verify the identity of the user submitting the approval, ensuring that the approval cannot be initiated or completed by someone other than the intended user. Though most corporate web applications might already have a required user login procedure before the web application can be accessed, the inventors have recognized a need for corporations to guard against a situation where a user leaves his machine unattended, leaving a possibility that someone other than the user could walk up to the machine already accessing the web application and falsely complete the approval.

Accordingly, the inventors have recognized a need for a corporation to collect an “electronic signature” which is verified to belong to the intended user and is associated with the user's approval of the given policy/procedure. The electronic signature typically will require the user to enter a password that verifies the user's identity. The electronic signature discussed herein is not necessarily a cryptographic digital signature requiring deployment of certificates and key management infrastructure; instead the term being used herein simply indicates a method to verify a user's identity via a password check and a secure method to record the user's approval.

For initially verifying a user's identity before access, some web applications use a login service that handles all the details of user authentication. In this scenario, a user accessing a web application is redirected first to the URL of the login service, so that the login service can collect the user's password or other information to verify the user's identity. Once the login service has performed its function to successfully verify the user's identity, the user can be admitted to the intended web application.

The problem with current systems that operate in this way is that there is no mechanism provided to verify the user's identity after login has been handled, e.g. to collect electronic signatures at some arbitrary time after login. Since the application relies on the login service to verify the user's identity, the web application itself has no means to verify the user's identity after login. For security reasons, it is undesirable to add a new service to verify user identities after login time. The user should become accustomed to responding to only a small standard set of password prompts which are recognizable as originating from the login service, so that the user is not as easily tricked by viruses and other rogue applications into supplying passwords to anyone who asks.

Some current web applications verify user identities after login time by assigning additional passwords to users or collecting various personal identification data (e.g. uSign product by eLynx). This approach allows an application to implement electronic signatures because the application has its own user password or identification data for which it can prompt when verifying the user's identity. However, from the web application point of view, implementing a special user password or collecting other data can be burdensome because the application must tackle the work to securely store and manage the information. From a user's point of view, it is best to streamline the number of passwords assigned to a user so that the user can remember these passwords. Rather than a web application implementing its own user passwords or other means to verify user identities, it would be more convenient and secure if the web application could rely on the login service to do this work to support electronic signatures.

### BRIEF SUMMARY OF THE INVENTION

The present invention addresses, among other things, the problems discussed above with using current user verification systems.

The present invention provides a login service including a function that is called by an application or server to verify the user's identity at some arbitrary time, including after the user is already logged into the application or server. The application may require that the user's identity is re-verified during operation of the application. This may occur, for example, at a time when the application requires a user to agree to a certain policy if the user would like to access a new service provided by the application. As a more specific example, corporate employees using a company's intranet may be required to agree to a company's transfer and re-location policy if they wish to continue as an employee for the company. In order for employees to continue to use the company's software to perform their job duties, the employee may be required agree to the policy on-screen, and to provide their password to verify their identity.

A login service provides this function whenever requested by a network or web application served by the login service. For example, Domino by IBM Corp. of White Plains, N.Y., which runs on a Lotus server by IBM, provides a login service to web applications. When the user first accesses a web application URL, the login service prompts a user for a login password. Once logged in, the user may then be granted access to the application and possibly to other applications, depending on the security configuration.

Many web applications can be served by this one login service. Many applications served by the one login service may each have a need to collect electronic signatures from its users, even after the user has logged in already. Rather than having each web application responsible for collecting electronic signatures verifying the identity of a user, this process is performed by the login service. With the present invention, an existing login service, such as the Domino system, can be extended to become a login-and-signature service, meaning that the application may call upon the Domino system to verify a user password during execution of the application upon request of the application, for example, when the application would like to verify that the user who initially logged in is the same user that is accepting the policy.

The application using the login-and-signature service may request a verification for a policy to be presented to a user. The application passes parameters to the service, including policy information which is to be agreed to by the user during verification. The login-and-signature service receives the request and policy information, and presents a screen displaying the received policy information and a prompt for receiving a password, or electronic signature, from the user. When this electronic signature is being received and verified, the policy information or policy being agreed to (or a brief summary thereof) is preferably displayed on the same page as the prompt for the user's password, thereby associating the electronic signature with a given policy. Some applications might require sequential pages (e.g. one page describes the policy and the next page only verifies the password), though this is not preferable since the user could become distracted during the transition between pages. The co-location of policy and password verification on one page leaves little doubt of the user's intent when approval is completed.

While it is preferable that policy information is displayed on the same page as the password prompt, it is also a preferable that the application maintains complete control of its own data and that the login-and-signature service needs no understanding of the application policy. Thus, there can be a separation of application vs. login-and-signature service responsibilities. Prior to the collection of an electronic signature, a web application first displays the full description of the policy it wants a user to approve, and a button that the user clicks to initiate approval. After the user clicks the button, the web application requests that the login-and-signature service collect an electronic signature from a user to guard against someone other than the user performing this action (e.g. at an unattended machine). The login-and-signature service manages all security aspects of user verification. To collect the electronic signature, the service prompts for the user's password and also displays a summary of the policy being agreed to, the text of which is passed to the service by the application (in a string parameter). After the user identity has been verified, the login-and-signature service securely transfers the results of the electronic signature procedure to the web application, and the web application resumes knowing definitively whether the approval was completed and by which user.

The requirement to enter a password adds authenticity to the process and guards against a user leaving a running web application unattended. If someone walks up to the unattended machine running a web application, that person can't, for example, sign-up the user for something without knowing the user's password. The ability to provide the password indicates that the intended user has completed the sign-up, and therefore facilitates the “electronic signature”.

In more specific terms, the invention is a user verification system for providing a user verification service which can be arbitrarily called by an application. The user verification system comprises a process independent from the application. A verification command is received from an application. The command contains at least some information for verification by a user. A login-and-signature service presents a screen to receive a password from the user. The screen contains the information for verification. The login-and-signature service verifies the password for the application. The verification system is independent from the application, and can service several related or unrelated applications. The information for verification may comprise policy information to be agreed to by a user. The policy information may, for example, relate to information a user must agree to in order to sign-up for a new service offered by the application.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram illustrating a networked system for providing a login service including a function that is called to verify the user's identity at some arbitrary time after login;

FIG. 2 is a flow diagram illustrating the steps performed by an embodiment of the login-and-signature verification system of FIG. 1;

FIG. 3 is a sample screen illustrating a sample policy screen preferably presented by the web application of FIG. 1;

FIG. 4 is a sample screen illustrating a sample policy verification presented by the login-and-signature verification system of FIG. 1 after it is called by an application in FIG. 1; and

FIG. 5 is a sample screen illustrating a sample verification confirmation screen.

### DETAILED DESCRIPTION OF THE PREFERRED EMBODIMENTS

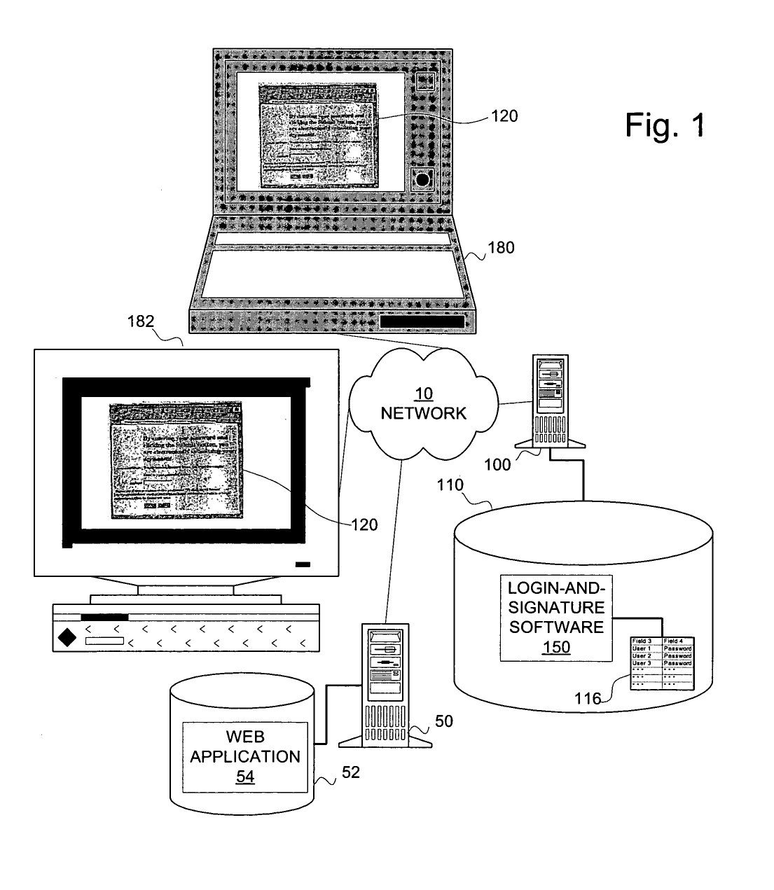

Preferred embodiments of the invention are now described with reference to the drawings. In accordance with the invention, and with reference to FIG. 1, a block diagram illustrates a networked system for providing a login service including a function that is called to verify a user's identity at some arbitrary time after login. An application server 50 stores a secure web application 54 in a storage device 50. The application server 50 is electronically connected to a network 10, which may comprise a company intranet, the internet, local area network, wide area network, or one of many other types of networks known to those skilled in the art. The web application 54 is available to one or more network user computers 200 and 300, and is identified by a URL if the network 10 type is an intranet or internet. Otherwise, the application may 54 be identified by an executable file name and folder in a file system.

A login service server 100 contains a storage device 110, which stores a login-and-signature software application or service 150, which is used by the web application 54 to present a login screen when a user of one of the user computers 200 or 300 attempts to access the web application. The login-and-signature software 150 is able to access a user information database 116, which contains fields containing user names and passwords, as is typical with web application login services such as Domino by the IBM Corp.

Before users are allowed to access the web application, electronic signatures may be collected, for example, in an on-line “sign-up” session (which may present policy screens and verifications itself). In an on-line sign-up session, either by user choice, or by a predetermined process flow, the user is transitioned to a page in the application 54 containing information on what the user is signing-up for. The login-and-signature service 150 is called to collect, among other data, username and password information for storage in the user information database 116.

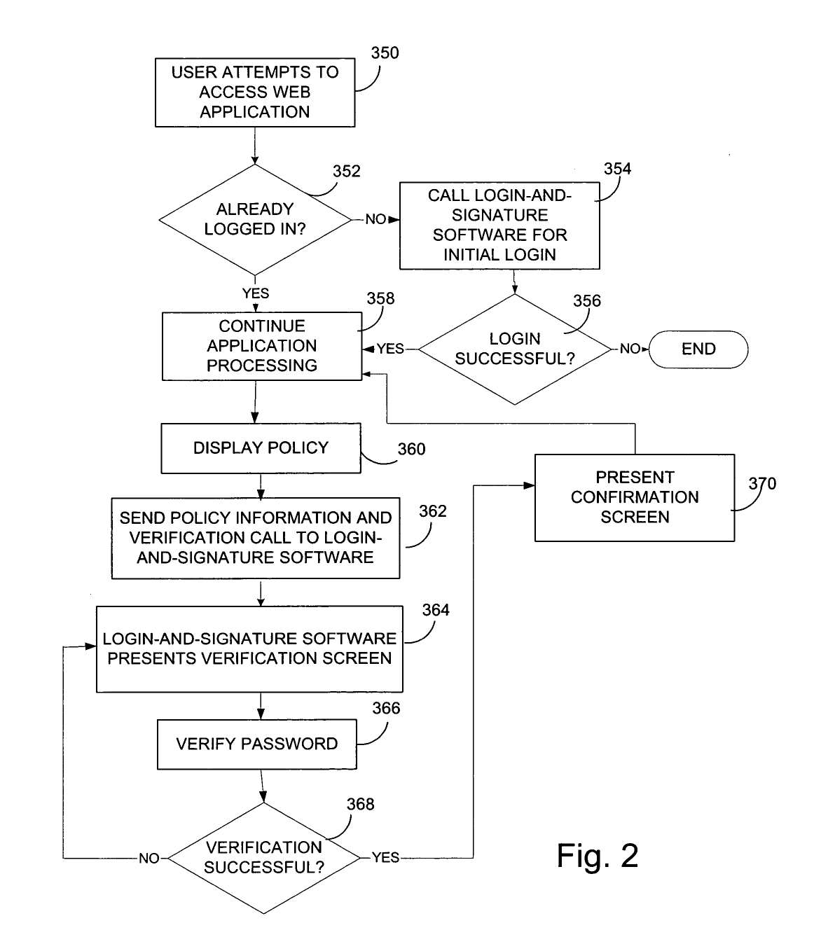

With reference to FIG. 2, a flow diagram illustrates the steps performed by the system 150 for login-and-signature verification according to an embodiment of the present invention. A company, for example, might have its corporate website implemented by the web application 54 and managed by the web application server 50. A user using a user computer 200 or 300 accesses the web application 54 by using a web browser for browsing to the application's web URL that directs the user to the application's server 50, step 350. The application program 54 is configured to store a variable that keeps track of whether a user has logged in already, and whether the user is merely just navigating back to the application's URL. If the user has not already logged in previously, step 352, then the application redirects the user's browser to the login-and-signature software 150 (which may be accessed through the URL location of the login service server 100 on which the login-and-signature software 150 resides), step 354. The initial login verification process as currently used by login service systems, such as the Domino login service, is executed by the login-and-signature software 150 to present a typical login screen on the user computer 200 or 300 to accept input for the username and password, which is checked against database 116 by the login-and-signature software 150. If the username and password fails to comply with any entry in the database 116, then the user may be kept in a loop by the login-and-signature software 150, continuing to present a login screen for at least a set number of times. If the user is not able to provide the correct username and password matching an entry in database 116, then the login was unsuccessful, and the user may be directed to a URL of the login service 150 to present a page explaining that the number of times given to the user for providing a valid username and password has been exceeded, and the user is not returned to the application 54 for further processing. Otherwise, if the login is successful, processing moves to step 358 for the continuation of application 54 processing.

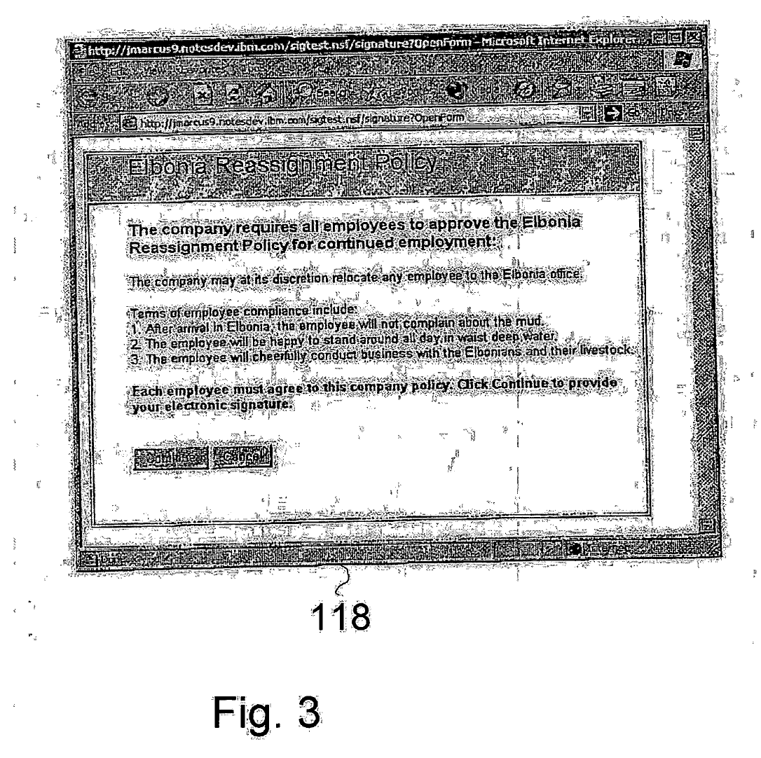

During processing of the application 54, the application 54, or a larger website of which the application 54 is a part, may require the user to approve one or several policies. For example, if a company web site wants to ask a user to approve a policy, the web application 54 re-directs the user computer 200 or 300 to the login-and-signature software 150. Preferably, an initial screen explaining the policy in detail is presented by the application itself before re-direction, step 360. An example screen 118 of a policy that may be presented to a user by the application is shown in FIG. 3.

With reference back to FIG. 2, in the re-direction process, unlike the initial login procedure described above, a command string containing policy information is sent to the login-and-signature software 150, step 362. For example, if the login-and-signature software 150 is a Domino login service that has been modified to add the functionality the present invention, the call to the login-and-signature software 150 may include a facility called an @command. In the case the Domino system embodiment, a URL agent may perform the request to the login-and-signature service 150. The purpose of the URL agent is to assist with the transition from the application 54 to the login-and-signature server 150. The URL agent collects the information from the application and formats the information for the @command into a URL. The URL destination is the login-and-signature service 150, with the application's 54 information passed as parameters to the @command. Thus the login-and-signature service 150 is transitioned to when the URL agent invokes the URL so that the login-and-signature service 150 may present a screen to receive a password from the user.

The @command is a script associated with the verification call to the login-and-signature software 150, and the effect of sending the @command is that control is transitioned to the login service server 100. The parameters for the @command include policy text and/or graphics to be presented to the user. The @command causes a Domino agent to run on the application server 50. A number of parameters are collected by the Domino agent for the @command to be sent with the @command to the login service server 100. The parameters may include:
A string or graphic to illustrate the policy (However, the application itself may present the policy before sending the @command in order to save on bandwidth usage);
A string with a short summary of the policy that the user is agreeing to (so that it can be displayed on the verification page);
A URL to transition to when the verification is completed successfully; and
A URL to transition to if the user cancels the verification or if the verification fails;

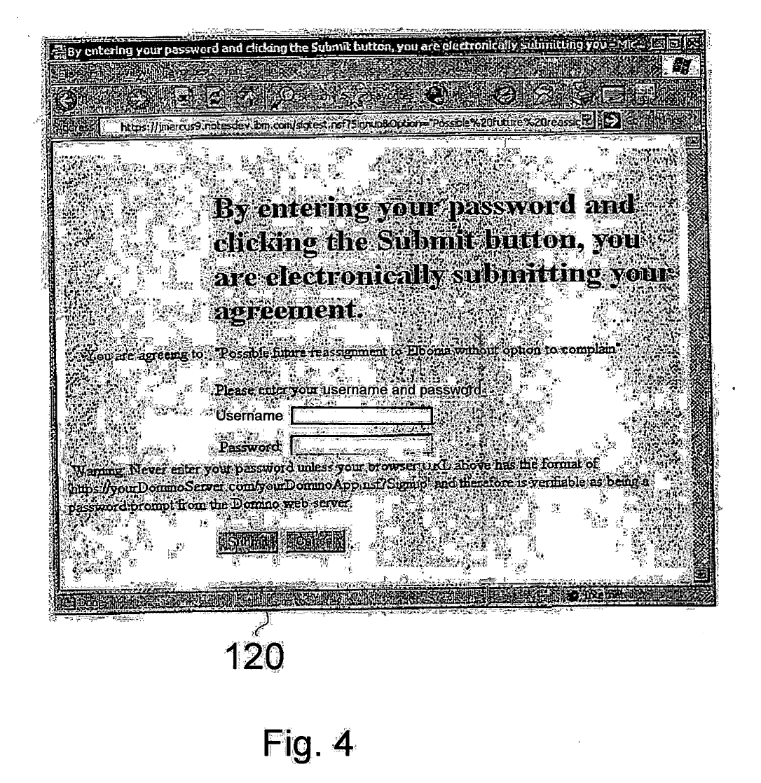

After receiving the re-direction command, processing is taken over by the login-and-signature software 150. The software 150 reads the policy information parameters included with the re-direct command, and presents a verification screen such as the example screen 120 shown in FIG. 4, step 364. The login software 150 receives a username and password entered by the user, which are then verified by the software 150 against the user information database 116, step 366. If the username and password combination does not match the same in the database 116, then processing moves back to step 364. If the user cancels verification on the screen (screen 120 in FIG. 4 and 120 in FIG. 1 on user computers 200 and 300), then the software 150 may re-direct the user's browser to the URL received from the web application 150 designated for if the user cancels verification.

If verification is successful, then a confirmation screen is presented to the user, step 370, by invoking a confirmation screen URL. Whether successful or not, the details of the verification are stored in a document in storage device 110. When the confirmation screen URL is invoked, the login-and-signature service 150 appends to the confirmation screen URL parameters a document identifier for information about the verification. Using the document identifier, the application can open the document to see the details of the verification and whether it was successful.

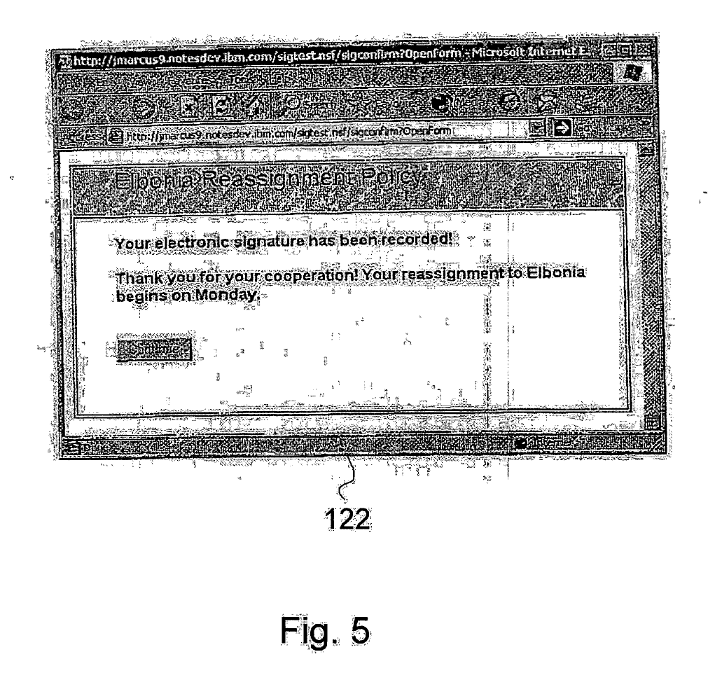

An example of a confirmation screen 122 is shown in FIG. 5. After presenting the confirmation screen 122, processing of the web application may then continue.

In some embodiments, the login-and-verification software 150 may perform operations to allow a user to sign-up for new services at the request of a web application 54. The @command may have a parameter to indicate that it is a sign-up command, or a new (sign-up command may be added to invoke a sign-up operation. Along with the parameters described above which are forwarded to the server 100 by the web application 54, the web application 54 forwards further parameters further regarding the service for which the user is signing-up, including any variables and form field definitions for the login-and-signature software 150 to present to the user during a sign-up process. For example, the policy screen 118 of FIG. 3 illustrates a policy that may be displayed if an employee of a company decides to sign-up to be eligible for promotions in the company. The policy provides a warning to employees that they must be prepared to be transferred to a different location, “Elbonia,” if they would like to be eligible for continued employment in the company. After processing is transferred to the login-and-signature software 150, an agent invoked by the software 150 constructs a sign-up URL. The URL includes the information received from the web application 54 as parameters to the @command that started the agent. Apart from the parameters referred to above, when the software 150 is directed to perform a sign-up operation, the web application 150 might pass the name of an approval log where the server 100 should record completed sign-up information. A copy of the information, including the actual pages presented and filled in by the user, may be stored in the approval log for future review. A timestamp for the sign-up session may also be stored. Further sign-up and time stamp information may also be written to the approval log.

In some embodiments, it is preferable for the login-and-signature software 150, or the web application 54, to save and store the currently displayed application web page before starting the verification or sign-up process. This is so it can be restored after a verification or sign-up operation if processing of the web application 54 is to continue from the saved page.

Finally, the login-and-signature software 150 may include a cleanup server agent that executes periodically to find verification or sign-up documents that were not completed.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. In a verification system, a method for providing a user verification service which can be arbitrarily called by an application comprising:
receiving a verification command from an application, the command containing at least some information for verification by a user, the verification command being received by the verification system which comprises a process independent from the application;
presenting a screen to receive a password from the user, the screen containing the information for verification; and
verifying the password for the application.

2. The method of claim 1, the information for verification comprising policy information to be agreed to by a user.

3. The method of claim 1, wherein the policy information relates to information a user must agree to in order to sign-up for a new service offered by the application.

4. A user verification system for providing a user verification service which can be arbitrarily called by an application, the user verification system comprising:
a data receiving device for receiving a verification command from an application, the command containing at least some information for verification by a user;
a programmed processor for presenting a screen to receive a password from the user, the screen containing the information for verification;
the programmed processor further for verifying the password for the application; and
the verification system being independent from the application.

5. The system of claim 4, the information for verification comprising policy information to be agreed to by a user.

6. The system of claim 4, wherein the policy information relates to information a user must agree to in order to sign-up for a new service offered by the application.

7. A computer program product having a computer readable medium having computer program logic recorded thereon for executing in a verification system for providing a user verification service which can be arbitrarily called by an application, comprising:
computer readable means for receiving a verification command from an application, the command containing at least some information for verification by a user, the verification command being received by the verification system which comprises a process independent from the application;
computer readable means for presenting a screen to receive a password from the user, the screen containing the information for verification; and
computer readable means for verifying the password for the application.

8. The computer program of claim 7, the information for verification comprising policy information to be agreed to by a user.

9. The computer program of claim 7, wherein the policy information relates to information a user must agree to in order to sign-up for a new service offered by the application.

10. In a verification system, a method for providing a user verification service which can be arbitrarily called by an application comprising:
receiving a verification command from an application, the command containing at least some information for verification by a user, the verification system for verifying that a user logged into the application is currently using the application;
presenting a screen to receive a password from the user, the screen containing the information for verification; and
verifying the password for the application.

11. The method of claim 10, the information for verification comprising policy information to be agreed to by a user.

12. The method of claim 10, wherein the policy information relates to information a user must agree to in order to sign-up for a new service offered by the application.

13. A computer program product having a computer readable medium having computer program logic recorded thereon for executing in a verification system for providing a user verification service which can be arbitrarily called by an application, comprising:
computer readable means for receiving a verification command from an application for which a user is already logged in to use;
computer readable means for presenting a screen to receive a password from the user, the screen containing the information for verification; and
computer readable means for verifying the password for the application.

14. The computer program of claim 13, the information for verification comprising policy information to be agreed to by a user.

15. The computer program of claim 13, wherein the policy information relates to information a user must agree to in order to sign-up for a new service offered by the application.
